(19) United States
(12) Patent Application Publication
(10) Pub. No.: US 2006/0067636 A1
(43) Pub. Date: Mar. 30, 2006

(54) Connector and splice holder device

(75) Inventors: Thomas E. Bludau, Austin, TX (US); James B. Carpenter, Austin, TX (US); William J. Clatanoff, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/212,320

(22) Filed: Aug. 26, 2005

Related U.S. Application Data
(60) Provisional application No. 60/613,169, filed on Sep. 24, 2004.

(51) Int. Cl. G02B 6/00

(52) U.S. Cl. 385/135

(57) ABSTRACT

An integrated connector and splice holder comprises a tray mountable in a telecommunications closure, the tray including a coupling port. An optical connector coupling is mounted in the coupling port. A first fiber connector that includes a first fiber pigtail extending therefrom is mounted on the connector coupling. A fiber splice device is securedly mounted on a first portion of the tray and receiving an end of the first fiber pigtail. A splice actuation mechanism integral with the tray is provided to actuate the splice device. A fiber clamp is provided to hold a position of the fiber pigtail. In addition, the integrated connector and splice holder can further include a fiber guide that is integrally formed on the tray and that can receive an optical fiber and that can guide the optical fiber to the splice device.

### CROSS REFERENCE TO RELATED APPLICATION

This application claims the benefit of U.S. Provisional Patent Application No. 60/613,169, filed Sep. 24, 2004, hereby incorporated by reference.

### BACKGROUND OF THE INVENTION

1. Field of the Invention

The present invention is directed to an integrated connector and splice holder device for telecommunication terminals and closures.

2. Related Art

Telecommunication cables are used for distributing data across vast networks. The majority of telecommunication cables are electrically conductive cables (typically copper), although the use of optical fiber cables is growing rapidly as larger and larger amounts of data are transmitted. As telecommunication cables are routed across networks, it is necessary to periodically open the cable and splice or tap into the cable so that data may be distributed to “branches” of the network. The branches may be further distributed until the network reaches individual homes, businesses, offices, and so on. The distributed lines are often referred to as drop lines. At each point where the cable is opened, it is necessary to provide some type of enclosure to protect the cable and allow easy and repeated access to the cable, such that technicians may easily access the cable to provide necessary services.

Enclosures for both electrical and optical telecommunication cables are generally known. For example, there are enclosures that receive one or more cables and contain some form of cable connection. Such enclosures often also contain storage means for storing unused conductive wires or optical fibers waiting for subsequent use. In some enclosures, splices in the cable and connection devices intended for subsequent connection to drop wires are maintained in separate areas of the enclosure, so as to reduce the possibility of damaging or disrupting cable splices during re-entry into the enclosure when connecting drop lines or the like.

Conventional enclosures are typically intended for use with electrically conductive telecommunications cables, and are not generally suitable for use with fiber optic cables, which have different constructions and performance concerns than electrically conductive cables. For example, optical fibers and their connections are more sensitive to their physical handling and the presence of debris such as dust, moisture, and the like. In addition, splicing optical fibers requires expertise and structures not required for electrical connections. An example optical fiber splicing structure is described in, e.g., U.S. Pat. No. 5,052,775.

### SUMMARY OF THE INVENTION

According to a first aspect of the present invention, an integrated connector and splice holder comprises a tray mountable in a telecommunications closure, the tray including a coupling port. An optical connector coupling is mounted in the coupling port. A first fiber connector that includes a first fiber pigtail extending therefrom is mounted on the connector coupling. A fiber splice device is securedly mounted on a first portion of the tray and receiving an end of the first fiber pigtail. A splice actuation mechanism integral with the tray is provided to actuate the splice device. A fiber clamp is provided to hold a position of the fiber pigtail.

In another aspect of the present invention, one or more fiber clamps integral with the tray can provide proper fiber orientation and position and can further provide splice and torsional strain relief.

In another aspect of the present invention, a fiber guide is integrally formed on the tray to receive an optical fiber and to guide the optical fiber to the splice device. The fiber guide can accommodate for the individual routing of fibers spliced therein.

In another aspect, the connector and splice holder device can further comprise a fiber splice cradle integral with the tray to secure the fiber splice device. In a further aspect, the tray can further include a multi-fiber splice device securedly mounted on a second portion of the tray and receiving an end of a second fiber pigtail. The multi-fiber splice device can be employed to splice the second pigtail fiber to a fiber from, e.g., a distribution ribbon cable.

According to another aspect of the present invention, an enclosure for a telecommunication cable having a plurality of telecommunication lines comprises an integrated connector and splice holder device, such as described above, securedly mounted therein.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The present invention will be further described with reference to the accompanying drawings, wherein:

FIG. 1 shows a side view of an integrated connector and splice holder device in accordance with an exemplary embodiment of the present invention.

FIG. 2 shows a top view of an integrated connector and splice holder device in accordance with another exemplary embodiment of the present invention.

FIG. 3 shows a top view of an integrated connector and splice holder device in accordance with another exemplary embodiment of the present invention.

FIG. 4 shows a side view of an integrated connector and splice holder device in accordance with another exemplary embodiment of the present invention.

FIG. 5 shows a top view of an integrated connector and splice holder device in accordance with another exemplary embodiment of the present invention.

FIG. 6 shows a top view of an integrated connector and splice holder device mounted within a telecommunications enclosure in accordance with another exemplary embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

The present invention is directed to an integrated connector and splice holder device for telecommunication terminals and closures. The exemplary integrated connector and splice holder devices described herein can be readily installed and utilized within conventional closures/terminals for Fiber To The Home (FTTH) and/or Fiber To The X (FTTX) network installations. The exemplary devices of the present invention can be utilized in installation environments that require ease of use when handling multiple splices and connections, especially where labor costs are more expensive. In addition, the exemplary devices of the present invention provide torsion and strain relief for both the distribution and drop cable fibers. Furthermore, splicing and connections to distribution cables can be accomplished without the need for additional splicing tools.

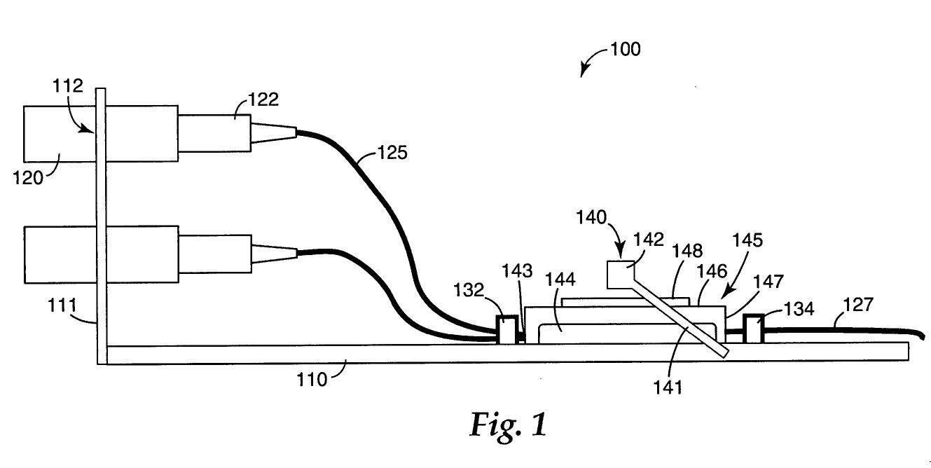

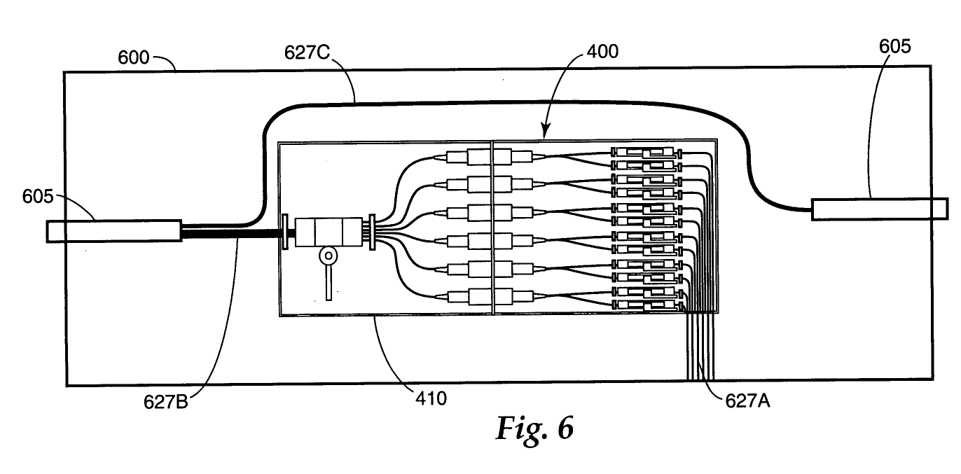

FIG. 1 shows a first exemplary embodiment of the present invention, an integrated connector and splice holder device 100 for telecommunication terminals and closures. An exemplary closure that can house device 100 is described below in connection with FIG. 6.

The device 100 includes a tray or platform 110 that is installable in a telecommunications terminal or enclosure. As shown in FIG. 1, the tray can hold and support an array of connector couplings and an array of splices, such as mechanical splices. The tray 110 can be constructed from a standard material, such as metal or plastic. Preferably, the tray is constructed from a molded plastic material, e.g., a suitable polymer material, such as polycarbonate, polyamide, polypropylene, polyethylene or the like.

Device 100 can further include a tray extension 111, which is integrally formed (e.g., by a suitable molding technique or machining) on tray 110. In an exemplary embodiment, tray extension 111 extends from the plane of tray 110 and further includes one or more connecting device ports 112, which can receive and secure a like number of optical connector couplings or adapters 120. Further, additional tray extensions (not shown) extending from other sides of tray 110 can be integrally formed with tray 110 to support further connector couplings in alternative embodiments. In a further alternative, the connecting device ports can be disposed directly onto tray 110.

Conventional fasteners and/or sealing mounts can be used to secure connector couplings 120 in ports 112. Although only two connector couplings are shown in FIG. 1, the integrated connector and splice device of the present invention can be designed to accommodate one or more optical connectors.

In an exemplary embodiment, the connector couplings 120 can be fully populated on one side of tray 110 with optical connectors, such as connectors 122. An additional set of connectors (not shown), such as from the distribution cable of a network, can be coupled into couplings 120 opposite the illustrated connector 122. This construction thus allows one side of the coupling to remain open for future insertion of similar connectors that are spliced into the distribution cable by the installer. The installer can then make the connection to the drop cable via the couplings.

Connectors 122 can include one or several different types of standard optical connectors, such as SC-type, FC-type, LC-type, and ST-type connectors. For example, when coupling into existing analogue/digital optical distribution cables, an exemplary SC-APC (angle polished connector) connector can be employed.

In addition, connectors 122 can include a fiber pigtail 125 whose end can be stripped and cleaved (flat or angled), or otherwise suitably prepared. Thus, connectors 122 can be pre-installed into the right side of the coupling 120 with a desired length of pigtail fiber 125 exiting from the back end of the connector 122, where the end of that pigtail fiber can be prepared for splicing and inserted part way into the splice device 145. According to an exemplary embodiment, this initial connectorization can be completed in the factory, prior to field termination.

Fiber pigtail 125 can comprise a standard single mode or multimode optical fiber, such as SMF 28 (available from Corning Inc.). In an exemplary embodiment, the fiber pigtail 125 has a 900 μm outer diameter buffered cladding (not including standard fiber jacketing), although fiber pigtail 125 can comprise any standard optical fiber buffered diameter, such as 250 μm, or fiber buffered diameters larger or smaller.

As shown in FIG. 1, in an exemplary embodiment, the fiber end of pigtail 125 can be installed into one end, e.g., splice port 143, of a splice device 145. In addition, according to an exemplary embodiment, a fiber clamp 132, can be provided at a location between the connector 122 and the splice device 145 to secure the fiber pigtail 125 in place. The fiber clamp can employ a conventional mechanism to grip and secure the pigtail fiber in place.

The fiber clamp 132 can be securely mounted on tray 110. Alternatively, at least a portion of fiber clamp 132 can be integrally formed (e.g., by molding) on tray 110. The fiber clamp 132 can minimize and/or prevent torsion stresses on the fiber 125, which can be a concern for 900 μm buffer coated fibers. Alternatively, clamp 132 can comprise a well that will accept an adhesive to secure the fiber 125. The clamp 132 can thus provide proper fiber location and orientation, (if orientation is required), for mechanical splicing.

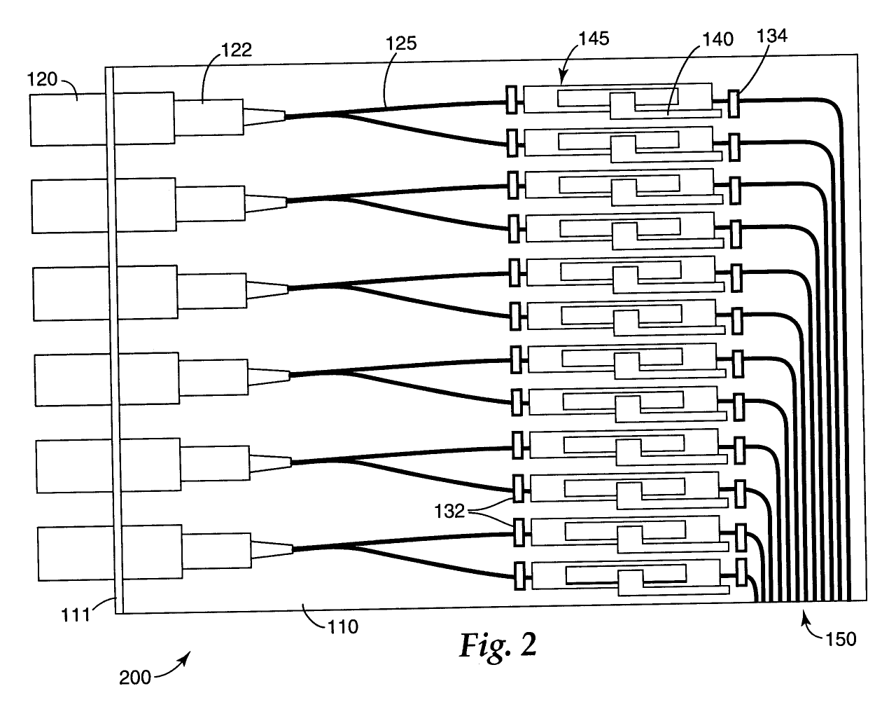

As described above, pigtail fiber 125 can be coupled to splice device 145. In an exemplary embodiment, splice device 145 comprises a mechanical splice device, such as a 3M™ FIBRLOK™ I mechanical fiber optic splice device, available from 3M Company, of Saint Paul, Minn. Although a single splice device 145 is shown in FIG. 1, multiple splice devices can be mounted onto tray 110 (see e.g. FIG. 2).

For example, commonly owned U.S. Pat. No. 5,159,653, incorporated herein by reference in its entirety, describes an optical fiber splice device (similar to the FIBRLOK™ II mechanical fiber optic splice device) that includes a splice element that comprises a sheet of ductile material having a focus hinge that couples two legs, where each of the legs includes a V-type (or similar) groove to optimize clamping forces for conventional glass optical fibers received therein. In addition, a conventional index matching fluid can be preloaded into the V-groove region of the splice element for improved optical connectivity within the splice element. Other conventional mechanical splice devices can also be utilized in accordance with alternative aspects of the present invention and are described in U.S. Pat. Nos. 4,824,197; 5,102,212; 5,138,681; and 5,155,787, each of which is incorporated by reference herein, in their entirety. The term “splice,” as utilized herein, should not be construed in a limiting sense since element 145 can allow removal of a fiber.

In an exemplary embodiment, utilizing a FIBRLOK™ II mechanical fiber optic splice device, splice device 145 can include a splice connector body 146 and a cap 148. In operation, as the cap 148 is moved from an open position to a closed position (e.g. downward in the embodiment depicted in FIG. 1), two cam bars located on an interior portion of the cap can slide over splice element legs (not shown), urging them toward one another. Two fiber ends, held in place in grooves formed in the splice element and butted against each other, are spliced together to provide sufficient optical connection, as the element legs are moved toward one another.

Splice device 145 is mountable in a mounting device or cradle 144. In an exemplary embodiment, cradle 144 is integrally formed in tray 110, e.g., by molding. Cradle 144 can secure (through e.g., snug or snap-fit) the axial and lateral position of the splice device 145. Alternatively, the splice device 145 can be secured to the tray 110 with a clamp type mounting device that is molded into the tray, and that allows removal of the splice if so desired. The mounting device can hold the splice device such that the splice device cannot be rotated, or easily moved forward or backward once installed.

As shown in FIG. 1, connector and splice holder device 100 further includes a splice actuator mechanism 140. The splice actuator mechanism 140 can be provided as a separate or integral structure with tray 110. In an exemplary embodiment, splice actuator mechanism 140 includes a splice actuator lever 141 that is integral to tray 110. In an exemplary embodiment, lever 141 is a rod formed as part of the molded tray 110 that has sufficient pliability to be bent from its normal orientation. Alternatively, lever 141 can be formed as a separate piece that is assembled to the tray 110 during factory assembly of the entire tray assembly. In addition, splice actuator mechanism 140 can include a splice cap driver 142 that is coupled to the end of lever 141. In operation, when a drop cable fiber, e.g., fiber 127, is inserted into splice device 145 through splice port 147, the actuating cap 148 can engage the mechanical splice element through the application of a force against driver 142. Thus, through the application of a modest force (e.g., by an installer depressing the lever/driver mechanism), the splice device 145 can be actuated to complete the splicing of the drop cable fiber 127 to the pigtail fiber 125. Alternatively, the lever/driver mechanism can be constructed as a push button device. These exemplary configurations allow for an installer to splice one or more drop cable fibers to a distribution cable without the need for additional splicing tools as the splice device and actuation mechanism can be integral with tray 110. In a further alternative, the splice device, actuation mechanism, and/or fiber clamps can be configured as is described in U.S. Provisional Application No. 60/691,881 (filed Jun. 17, 2005), incorporated by reference herein in its entirety.

As is further shown in FIG. 1, a second fiber clamp 134, of similar or different construction as fiber clamp 132, can be mounted or integral with tray 110 to secure drop cable fiber 127 and provide torsional and strain relief for the drop cable fiber. In addition, fiber clamp 134 can be utilized to hold a drop cable fiber 127 in place to allow for one-handed splicing through the use of the splice actuation mechanism described above.

FIG. 1 above represents one possible configuration of an integrated connector and splice holder device 100. Utilizing this approach, connectors and splices that can be pre-assembled in a factory onto the tray design. In addition, integrated connector and splice holder device 100 can be pre-assembled into a closure/terminal.

FIG. 2 shows another exemplary embodiment of the present invention, an integral connector and splice holder device 200. In this example construction, a 2×6 array of connectors 122 is provided (note that FIG. 2 only depicts a first row of connector couplings 120 for simplicity). In this embodiment, SC-APC connectors 122 can be utilized, with connector couplings 120 being secured in ports 112 located on the left side of the tray 110 or extension 111. Alternatively, the connectors and coupling combination can be replaced by a connector-socket (e.g., plug-receptacle) arrangement.

Connector and splice holder device 200 further includes a row of multiple (12 in this figure) splice devices 145, located on the right side of the tray. As with the embodiment of FIG. 1, the connectors and mechanical splices can be of any number of types. Actuation of splice devices 145 can be accomplished through one or more splice actuators 140, integrally formed on tray 110, such as described above. In addition, connector and splice holder device 200 can further include fiber clamps 132 and 134 to provide proper fiber location, orientation, and strain relief, as is described above.

FIG. 2 further depicts another exemplary aspect of connector and splice holder device 200, namely a set of fiber guides or grooves 150 integrally formed in tray 110. In an exemplary embodiment, grooves 150 are molded into the tray as a guide for the drop cable fibers 127 that will be inserted and spliced to the connector fibers already located in the splice devices 145. The grooves can be sized to receive and support fiber buffer or jacket diameters. The grooves 150 can also be curved on the surface of tray 110 in such a manner as to bend the fibers with an appropriate bend radius. The drop cable fibers can be placed in the guides 150 either before or after splicing. The separation of fibers on tray 110 further provides fiber management of the drop cable fibers, e.g., by keeping the fibers 127 independent form each other. For example, in the case where one fiber were to be pulled with such force that the fiber breaks at the splice and pulls out (e.g., if a tree were to fall on one customer's house), such breakage or displacement would not disturb the fibers located on either side of that fiber. In contrast, conventional closures include drop cables that are wrapped about a single spool—thus a major breakage or pull could impact the other fibers in service.

Optionally, device 200 may further include a cover (not shown) to further protect the contents of the tray, if so desired.

The connector and splice holder device 200 configuration shown in FIG. 2 represents one of many possible configurations. For example, the tray 110 may be designed to hold two connectors and two splices. If twelve were desired, then six 2×2 units could be installed into the closure/terminal to meet this requirement. Any number of connector/splice combinations is possible in accordance with embodiments of the present invention.

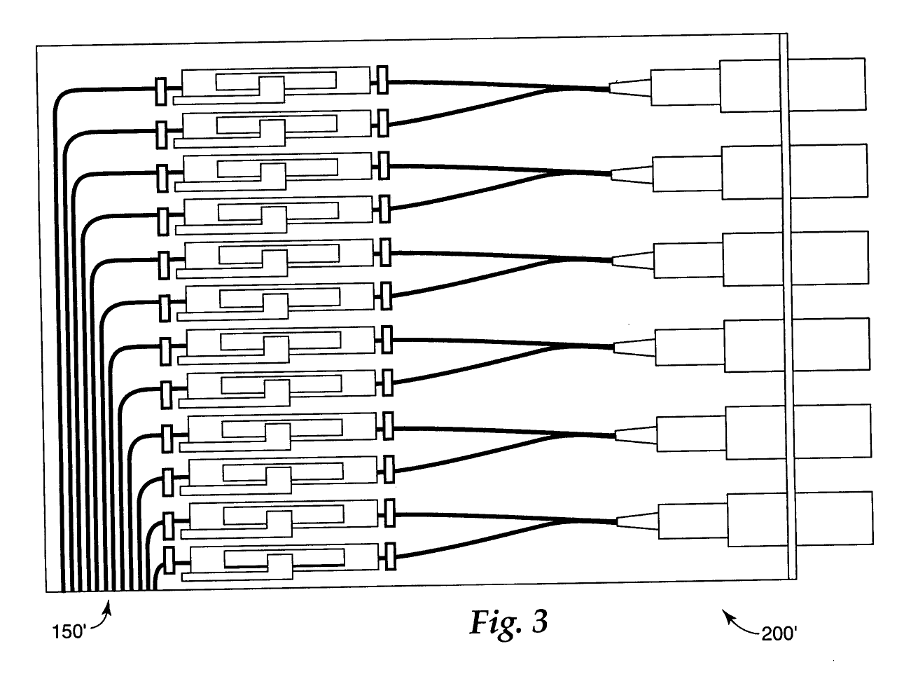

As shown in FIG. 2, drop cable fibers (e.g., emanating from a number of customer locations) are provided at the right hand side of the figure. As shown in the alternative embodiment of FIG. 3, a reverse configuration may also be employed. In this example, a connector and splice holder device 200′ can include its drop cable fiber guides 150′ on the left hand side of the tray 110. As described herein, the terms “left” and “right” are not meant to be limiting, but merely for convenience, as the orientation of the connector and splice holder device can be revered or rotated, as would be apparent to one of ordinary skill in the art. All other features can be similar to that described above for FIG. 2.

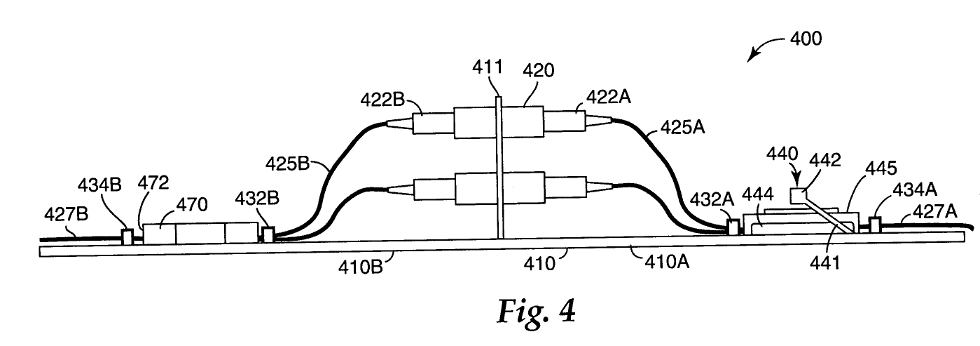

In accordance with another exemplary embodiment, FIG. 4 shows a side view of a connector and splice holder device 400 that can provide for coupling of a multi-fiber ribbon assembly from a distribution cable to drop cable fibers in an integrated connector and splice unit. In this configuration, a continuous tray or platform 410 can include a drop cable section 410A and a distribution cable section 410B. A tray extension 411 can be centrally located in device 400 and can support connector couplings 420 in a manner similar to that described above in regards to FIG. 1.

In this exemplary configuration, the features of drop cable section 410A are similar to that described above with respect to FIG. 1, with fiber pigtail 425A, fiber clamps 432A and 434A, splice device 445, integral splice actuation mechanism 440, and splice cradle 444 having similar construction and functionality with counterpart features from FIG. 1.

In this configuration, connectors 422A and 422B, such as SC-APC connectors, which are coupled to fiber pigtail 425A and fiber ribbonized pigtail 425B, respectively, can be pre-installed in both the drop cable and distribution cable sections. Alternatively, couplings 420 can be constructed to couple different types of standard connectors to each other, if desired.

As shown in FIG. 4, within distribution cable tray section 410B, a prepared end of a fiber ribbonized pigtail 425B can be spliced to a fiber from a multi-fiber distribution ribbon cable 427B utilizing a multi-fiber splice device 470. The multi-fiber splice device 470 can comprise a single structure, such as those described in U.S. Pat. Nos. 5,155,787 and 5,151,964, incorporated by reference herein in their entirety. For example, a Multifiber FIBRLOK™ splice, available from 3M Company, St. Paul Minn., can be utilized. Alternatively, a fusion splice can be utilized in the place of multi-fiber splice device 470.

In an exemplary embodiment, a single fiber clamp unit 432B, located between splice device 470 and connectors 422B can be integral with or securely mounted within distribution cable tray section 410B to hold fiber ribbonized pigtails 425B. Fiber clamp unit 432B can comprise a conventional mechanism for clamping a fiber ribbon. Alternatively, fiber clamp 432B can comprise individual fiber clamps, such as fiber clamps 132, described above with respect to FIG. 1.

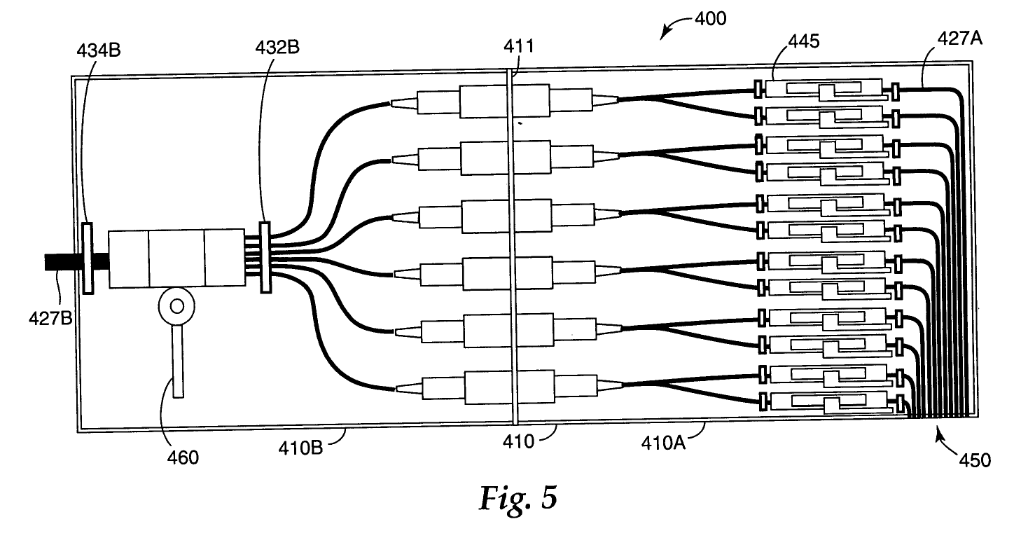

In addition, distribution cable tray section 410B further includes a multi-fiber splice actuation mechanism 460 (shown in FIG. 5) to actuate the multi-fiber splice device 470. Device 470 can comprise a lever, separate from or integral to the tray 410, which actuates a wedge structure to activate the splice, such as described in U.S. Pat. No. 5,155,787, incorporated by reference above. In operation, ends of fibers from a fiber ribbon cable 427B, comprising a ribbon array of individual fibers (e.g., 12 fibers) emanating from the main distribution cable (see e.g., FIG. 6), would be prepared and inserted into a fiber receiving portion 472 of multi-fiber splice device 470. When actuated, multi-fiber splice device 470 would optically splice the distribution cable to one or more fibers located in the drop cable section 410A of tray 410.

Distribution cable section 410B can further include a fiber ribbon clamp 434B located before the fiber receiving portion 472 of multi-fiber splice device 470. Fiber clamp 434B can be constructed in the same manner as fiber clamp 432B. Thus, fiber ribbon clamp 434B can be implemented to provide strain relief for the distribution cable fiber ribbon 427B.

FIG. 5 shows a top view of connector and splice holder device 400. In this exemplary embodiment, a row of multiple (12 in this figure) splice devices 445 can be provided in drop cable section 410A. In addition, a set of fiber guides or grooves 450 integrally formed in tray section 410A can provide guides for the drop cable fibers 427A that will be inserted and spliced to the connector pigtail fibers 425A already located in the splice devices 445. Guides 450 can be constructed in a manner similar to guides 150, described above with respect to FIG. 2. Thus, connector and splice holder device 400 provides a single tray mountable in a telecommunications closure or terminal that can be used to couple one or more distribution cable fiber ribbons to drop cable fibers.

FIG. 6 shows an exemplary integrated connector and splice holder device, such as device 100, device 200, or device 400 (shown in the figure) mounted in a telecommunications terminal or closure 600. The enclosure 600 can be designed to protect the connections and splices supported within from damaging interference due to weather elements, dust, animals, and other elements. Further, the enclosure 600 can be designed to permit re-entry by an installer. For example, the enclosure 600 can be a conventional enclosure unit, such as SliC™ closure/terminal, a 3M™ FibrDome terminal, or 3M™ BPEO closure, available from 3M Company, St. Paul, Minn. For example, the enclosure 600 can be designed in accordance with the structure described in commonly owned and co-pending U.S. application Ser. No. 10/916,332, incorporated by reference herein, in its entirety. Terminal/closure 600 includes an enclosure body that can be constructed from an appropriate rugged material. Terminal/closure 600 can be an above-grade (i.e., above-ground) enclosure, and can be further adapted to be suspended from a support cable (not shown) by, e.g., means of a pair of hangers. In other embodiments, terminal 600 may be a below-grade (i.e., below-ground) enclosure.

As shown in FIG. 6, a distribution cable 605 (e.g., such as provided by a telecommunications network), comprises one or more fiber ribbons 607A and 607B (with each ribbon, e.g., comprising 12 individual fibers). Distribution cable 605 can be secured in terminal 600 via, e.g., a crimping or clamping mechanism (not shown). In one exemplary implementation, a first fiber ribbon 627B is removed from a portion of the distribution cable 605 and is to be coupled to one or more drop cables 627A, each originating at the home of a network customer. The remaining fiber ribbons 627C of the distribution cable 605 are not removed.

The individual fibers of ribbon 627B can then be connected to individual drop cable fibers 627A utilizing device 400, in the same manner as described above with respect to FIGS. 4 and 5. Device 400 can be installed and secured within closure 600 by a conventional fastening mechanism (e.g., by bolting or screwing device 400 in an interior chamber of closure 600).

Thus, utilizing this approach, optical fiber terminations can be simplified by employing a closure/terminal that includes the above-described integral tray that is preloaded with the desired amount of connectors and corresponding splices. This construction will save the installer time, and improve quality as compared to a “custom” installation, where all assembly would take place on site. When the connector/splice tray is fully enclosed in the closure/terminal, the requirement for a special environmental housing can be eliminated. In addition, the installation of the distribution cable pigtail connectors can be readily accomplished—after the pigtails are spliced to the distribution cable, they would be simply plugged into the couplings pre-installed in the tray.

The connection of the drop cable to the closure/terminal utilizing one or more of the exemplary embodiments described herein would also have an advantage in that the desired length of cable can be made between the home and the closure/terminal, eliminating the need for cable slack storage. The installer can perform basic cable preparation, e.g., stripping the cable and cleaving the fiber in preparation to install the fiber into the splice device. After the fiber is prepared, the fiber is inserted into the splice and the splice can be actuated without the need for a separate splice tool. Alternatively, the fiber can be inserted into the back of the splice device, while that fiber is held in position with the fiber clamp located behind the splice device.

When the fiber is aligned in the proper position, the splice can then be actuated. The other end of the splice can be preloaded with a fiber from a connector pigtail that is located on the end of the tray, and the fiber can be held in place with a fiber clamp, such as described above. In addition, the integral tray can provide fiber management—if a drop cable is pulled with a force greater than that of the strength of the cable, the fiber will break at the end of the splice, and pull out, without disturbing the cables next to it.

In accordance with the present invention, the exemplary integrated connector and splice holder devices described above can be readily installed and utilized within conventional closures/terminals for FTTH and/or FTTX, network installations. The devices of the present invention can be utilized in installation environments that require ease of use when handling multiple splices and connections, especially where labor costs are more expensive. In addition, the connector coupling is housed in a larger environmental protected housing.

For example, with an exemplary connector and splice pre-populated tray, as described above, installed into a closure/terminal, the FTTH/FTTX network installer can hang the closure/terminal at its predetermined location, make connection between the distribution cable via the connector array installed in the tray, and connect the drop cables from the subscribers' homes via the mechanical splices also installed in the tray. When the drop cables are installed, the installer can prepare the fiber by stripping it, cleaving it, inserting it into the open end of the splice, and actuating the mechanical splice with the actuation device provided on the tray, and without the need for an additional separate splicing tool.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An integrated connector and splice holder, comprising:
a tray mountable in a telecommunications closure, the tray including a coupling port;
a connector coupling mounted in the coupling port;
a first fiber connector connected to the connector coupling that includes a first fiber pigtail extending therefrom;
a fiber splice device securedly mounted on a first portion of the tray and receiving an end of the first fiber pigtail in a first splice port;
a splice actuation mechanism disposed on the tray to actuate the splice device; and
a first fiber clamp to hold a position of the fiber pigtail.

2. The integrated connector and splice holder of claim 1, further comprising:
a fiber splice cradle integral with the tray to secure a position of the splice device.

3. The integrated connector and splice holder of claim 1, further comprising:
a tray extension extending from the tray, wherein the ports are located in the tray extension.

4. The integrated connector and splice holder of claim 1, further comprising:
a multi-fiber splice device securedly mounted on a second portion of the tray and receiving an end of a second fiber pigtail.

5. The integrated connector and splice holder of claim 4, wherein the first fiber pigtail is connected to the second fiber pigtail via the connector coupling.

6. The integrated connector and splice holder of claim 1, wherein the splice actuation mechanism comprises a lever formed on said tray and a driver formed on an end of said lever and adapted to contact a portion of the splice device.

7. The integrated connector and splice holder of claim 1, further comprising at least one fiber guide integral with the tray to receive an optical fiber and to guide the optical fiber to the splice device.

8. The integrated connector and splice holder of claim 7, further comprising a second fiber clamp to hold a position of the optical fiber inserted into the splice device.

9. An enclosure for a telecommunication cable having a plurality of telecommunication lines, comprising:
an enclosure body; and
an integrated connector and splice holder device securedly mounted to the enclosure body, the integrated connector and splice holder, comprising:
a tray mountable in the enclosure, the tray including a coupling port;
a connector coupling mounted in the coupling port;
a first fiber connector connected to the connector coupling that includes a first fiber pigtail extending therefrom;
a fiber splice device securedly mounted on a first portion of the tray and receiving an end of the first fiber pigtail in a first splice port;
a splice actuation mechanism disposed on the tray to actuate the splice device; and
a first fiber clamp to hold a position of the fiber pigtail.

10. The enclosure of claim 9, further comprising:
a distribution cable having at least one distribution cable fiber coupled to a connector mounted on the connector coupling.

11. The enclosure of claim 9, further comprising:
a fiber splice cradle integral with the tray to secure a position of the splice device.

12. The enclosure of claim 9, further comprising:
a tray extension extending from the tray, wherein the ports are located in the tray extension.

13. The enclosure of claim 9, further comprising:
a multi-fiber splice device securedly mounted on a second portion of the tray and receiving an end of a fiber from the distribution cable and an end from a second fiber pigtail.

14. The enclosure of claim 13, wherein the first fiber pigtail is connected to the second fiber pigtail via the connector coupling.

15. The enclosure of claim 9, wherein the splice actuation mechanism comprises a lever formed on said tray and a driver formed on an end of said lever and adapted to contact a portion of the splice device.

16. The enclosure of claim 9, wherein the integrated connector and splice holder further comprises at least one fiber guide integral with the tray to receive a drop cable fiber and to guide the drop cable fiber to the splice device.

17. The enclosure of claim 16, further comprising a second fiber clamp to hold a position of the drop cable fiber inserted into the splice device.
